(19) United States
(12) Patent Application Publication
(10) Pub. No.: US 2023/0348306 A1
(43) Pub. Date: Nov. 2, 2023

(54) PROCESS FOR THE SUPERCRITICAL OXIDATION OF SEWAGE SLUDGE AND OTHER WASTE STREAMS

(71) Applicant: SCFI LIMITED, Cork (IE)

(72) Inventors: John O'REGAN, Waterfall, County Cork (IE); David McGARRY, Cork (IE)

(73) Assignee: SCFI LIMITED, Cork (IE)

(21) Appl. No.: 17/911,220

(22) PCT Filed: Mar. 30, 2021
(86) PCT No.: PCT/EP2021/058361

§ 371 Date: Sep. 13, 2022

(30) Foreign Application Priority Data
Apr. 6, 2020 (EP) 20168182.2

(51) Int. Cl. C02F 11/08; C02F 1/00; C02F 1/20; C02F 1/66

(52) U.S. Cl. CPC C02F 11/086; C02F 1/006; C02F 1/20; C02F 1/66; C02F 2209/02; C02F 2209/03; C02F 2209/06; C02F 2209/225; C02F 2209/40; C02F 2209/44; C02F 2303/08; C02F 2303/10; C02F 2303/22; C02F 2301/046; C02F 2209/08; C02F 2209/006; C02F 2201/002

(57) ABSTRACT

A process performed by a plant for oxidation of a waste stream with oxidizable material is described. In a start-up phase, supercritical water is fed to a supercritical water oxidation reactor, heating the process up to supercritical conditions. In a treatment phase, the waste stream is fed to the reactor for supercritical water oxidation treatment, in which sufficient mass of water under supercritical conditions is present in the reactor to retain supercritical conditions with the newly introduced waste stream. Oxygen is used as oxidant and a stoichiometric quantum is added to the reactor. The energy released from the oxidation reaction substitutes the energy provided by the addition of supercritical water up to a point where the reactor achieves near autothermal conditions with supercritical water providing trim heat requirement. The reactor outlet is quench cooled, neutralised and energy is recovered from it. A gas liquid separator ensures that the effluent stream is degassed.

### INTRODUCTION

The invention relates to oxidation of sewage sludge and other wastes.

Stringent regulations and controls regarding sewage sludge handling, treatment and disposal are drawing increasingly more attention towards focussing on sustainable options for wastewater treatment.

Ocean dumping of sewage sludge has long been banned and landfilling of sewage sludge is under stringent regulatory restriction due to the presence of pathogens, heavy metals and toxic organic compounds. The cost of sewage sludge incineration is extremely high due to the regulations that apply to the effluent flue gas from the process and due to the high energy requirement for drying of the sludge.

A number of different alternative technologies have gained extensive research and development with the aim of treatment and minimisation of sewage sludge. Some of these technologies include enzymatic hydrolysis, mechanical and thermal treatment, chemical and thermochemical hydrolysis, ultrasound treatment, various oxidation processes using ozone, air, oxygen and hydrogen peroxide as oxidant, hydrothermal oxidation (such as wet oxidation), uncoupled metabolism and microbial predation.

However, there is still a need for a process that allows for full destruction of sewage sludge waste that is not incineration and does not need to evaporate the high-water content present within sewage sludge.

Wet Air Oxidation (WAO) has received specific research attention for minimisation of sludge, however, achieving COD reductions in excess of 90% requires process equipment allowing for residence times in excess of 60 minutes. The use of air as opposed to oxygen further increases equipment size and the capital investment requirement. The WAO process is operated at a temperature of 200-320° C., requires high energy input for extended periods and results in a high chemical oxygen demand effluent which must be returned to the sewage works causing an increased load on the system. This degrades the merit of utilising WAO for the treatment and minimisation of sewage sludge.

Other studies have been conducted to investigate the use of dual step processes, combining anaerobic digestion prior to WAO. The purpose of these studies was to investigate the possibility of harnessing valuable gas i.e. methane, that can be used to offset the high energy requirement for the WAO process. Methane gas can be produced from this anaerobic digestion, however, these studies do not address the footprint size requirement for the WAO plant or the fact that there is still a large residual COD load to be returned to the sewage works.

The need exists for a process achieving near complete destruction of COD, while at the same time having a small footprint and a low steady state energy requirement.

Supercritical water oxidation (SCWO) of sewage sludge presents an alternative to the above processes. SCWO presents the opportunity for complete autothermal destruction of all organics present within the sludge without the need for the removal of the water content, excellent energy recovery, together with the possibility to recover useful by-products including phosphorous and carbon dioxide. SCWO provides complete destruction of harmful components in the sewage sludge and volatile suspended solids (VSS) destruction efficiencies of up to 99.9% can be achieved in less than 2 minutes. Carbon dioxide (CO₂) and clean water are the main oxidation products from SCWO along with excess O₂ contained within the reactor effluent.

The drawbacks related to SCWO of sewage sludge include to various degrees the requirement of the process to cope with organic bake and inorganic salt precipitation within heat exchangers and reactors at supercritical water conditions and the concerns related to corrosion and erosion of downstream processing equipment, ineffective harnessing of the energy released from the oxidation reactions, ineffective heat recovery from the processed sewage sludge reactor effluent stream, and/or high cost of oxygen due to the requirement to supply the reactor with stoichiometric plus very significant excess oxidant.

The presented invention addresses these and other concerns.

### SUMMARY OF THE INVENTION

The invention provides a method for oxidation of a waste stream as set out in claim 1 and dependent claims 2 to 29, and also an apparatus for such treatment as set out in claim 30 and its dependent claims 31 to 34.

We describe in various examples a process performed by a plant for oxidation of a waste stream with oxidizable material is described. In a start-up phase, supercritical water is fed to a supercritical water oxidation reactor, heating the process up to supercritical conditions. In a treatment phase, the waste stream is fed to the reactor for supercritical water oxidation treatment, in which sufficient mass of water under supercritical conditions is present in the reactor to retain supercritical conditions with the newly introduced waste stream. Oxygen is used as oxidant and a stoichiometric quantum is added to the reactor. The energy released from the oxidation reaction substitutes the energy provided by the addition of supercritical water up to a point where the reactor achieves near autothermal conditions with supercritical water providing trim heat requirement. The reactor outlet is quench cooled, neutralised and energy is recovered from the reactor effluent stream by means of pre-heating water to the supercritical water heater and the waste feed heater. The pressure let-down system uses choke water in combination with an arrangement of capillary coils to reduce the pressure to atmospheric conditions. A gas liquid separator ensures that the effluent stream is degassed, releasing off gas, mainly CO₂ and excess O₂ to the atmosphere. Online oxygen analysis on the off-gas stream limits the addition of oxidant to stoichiometric amounts. Liquid effluent flows under gravity or is pumped to disposal.

We describe a method performed by a plant for oxidation of a waste stream with oxidizable material, the process comprising the steps of:
in a start-up phase feeding supercritical water to a reactor, gradually introducing waste and oxidant, and simultaneously decreasing supercritical water feed while maintaining supercritical conditions in the reactor, and
in a treatment phase, then feeding the waste stream with oxygen to the reactor for supercritical oxidation, in which sufficient mass of water under supercritical conditions is present to retain supercritical conditions with the energy released from oxidising the introduced waste stream.

Preferably, a separate supercritical water generator supplies supercritical water to the reactor. Preferably, the method includes varying waste stream feed rate to maintain the reactor in balance and at a temperature in excess of 374° C. and pressure in excess of 230 bar. Preferably, Oxygen is used as the oxidant and it is dosed in ratio to the waste stream feed to the reactor at stochiometric quantum, and the reactor is sized to ensure that sufficient retention time is available to allow for the oxidation reaction to complete. Preferably, the reactor operating temperature is in the range of 425° C. to 550° C.

The method may include quench cooling at the reactor outlet to quench the treated effluent stream preventing corrosion downstream from the reactor. Preferably, the quenching reduces temperature of the effluent stream to a value in the range of 200° C. to 300° C., preferably 240° C. to 260° C.

Preferably, heat is recovered from the effluent stream for preheating of the sludge fed to the reactor. Preferably, a neutralisation agent is dosed with the quench water to the bottom of the reactor with the purpose of adjusting the reactor effluent pH.

Preferably, in the start-up phase demineralised water is fed to a deaerator drum and subsequently pumped using a high-pressure water pump, pressurizing the plant to elevated pressure above 220 Bar, more preferably 230 Bar to 250 Bar, and when the plant is at the desired operating pressure, a supercritical water heater heats the start-up phase water feed to a temperature in the range of 380° C. to 650° C., preferably 520° C. to 570° C.

Preferably, heat is recovered from the reactor outlet effluent stream and is used by a heat exchanger to preheat the sludge fed into the reactor to a value in the range of 50° C. to 200° C.

Preferably, the waste feed to the reactor is distributed prior to injection into the reactor. Preferably, feed is distributed using a distributer equipped with temperature control, avoiding distributor wall temperatures that promote bake-on and/or fouling and sub-sequent distribution channel blockage.

Preferably, the method includes rapid heating of waste feed by means of increased surface area for heat transfer between the distributed waste and the reactor content at supercritical conditions.

Preferably, the reactor conditions are such that the sewage sludge rapidly heats due to the supercritical water conditions, so that the sludge displays near immediate transition from liquid to the supercritical phase, with the accompanying changes in solvency properties, and in which inorganic salts, display characteristics of a non-polar solvent, and not allowed time for crystal growth, precipitate from solution as dry salts.

Preferably, the waste stream is delivered to the reactor fitted with a liner which serves as a surface for preferential salt collection during steady state operation, which may be at a temperature in the range of 380° C. to 650° C. Preferably, the liner is configured to meet salt nucleation site requirements and angle of inclination for collecting specific salts presented in the feed.

Preferably, the liner is non-pressure bearing and has a thermal expansion coefficient different from the collected salt scaling and/or fouling layer, allowing controlled release of collected salts by deliberately altering the reactor temperature. Preferably, for the purpose of reactor descaling, the reactor content is quench cooled, for example, by adding quench water to the top of the reactor, including allowing the reactor liner to contract with the subsequent dislodgment of scale build-up.

Preferably, after heat recovery from the reactor effluent stream, cooling water is used to cool the effluent stream to a value in the range of 40° C. to 60° C. before a pressure let-down step in which the effluent pressure is reduced to atmospheric pressure. Preferably, the pressure drop is achieved by introduction of choke water and subsequently passing the effluent stream through a capillary coil for a gradual pressure let-down without the use of hard restrictions such as valves or orifice plates. Preferably, the reduced-pressure effluent stream is processed by a gas-liquid separator from which a gas-free liquid effluent is disposed.

Preferably, oxygen measurement of the effluent gas stream is performed and oxygen input to the reactor is controlled accordingly to achieve desired COD destruction. Preferably, there is a gradual switch-over from the start-up phase to achieve auto-thermal reactor conditions.

We also describe a treatment apparatus comprising process components including a controller with a data processor and a supercritical reactor and adapted to perform the steps of any method described herein.

Preferably, the reactor is vertically arranged. Preferably, the reactor comprises a distributor adapted to receive the waste stream fed to the top of the reactor to allow for temperature control of the distributor walls, minimising bake-on and/or fouling and subsequent blockage of the distribution channels.

Preferably, the reactor comprises a non-pressure bearing liner with a capability to expand and contract, such that based on a difference in thermal expansion coefficients between the liner and accumulated solids, controlled cracking and subsequent dislodgement of the solids can be achieved by altering the temperature of the reactor. Preferably, the reactor outlet, for example at the bottom, is lined with a corrosive-resistant material, allowing for quenching reactor effluent to sub-critical temperatures while at the same time, limiting corrosion related to passing through the transition from supercritical to sub-critical conditions.

### DETAILED DESCRIPTION OF THE INVENTION

The invention will be more clearly understood from the following description of some embodiments thereof, given by way of example only with reference to the accompanying drawings in which:

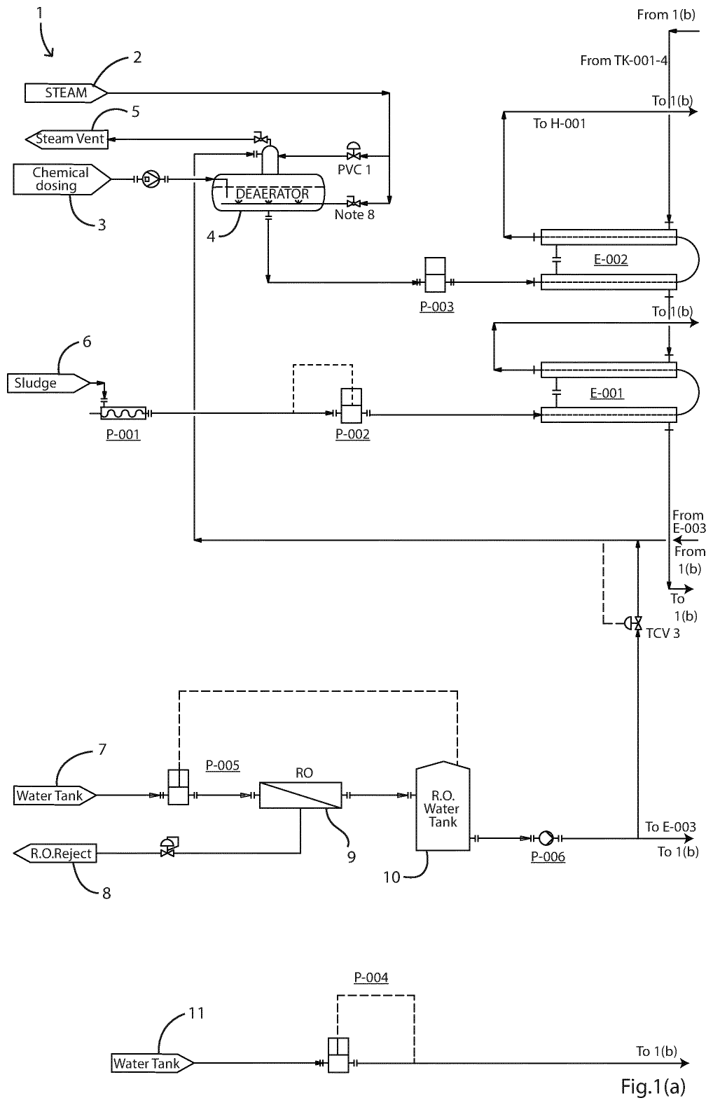

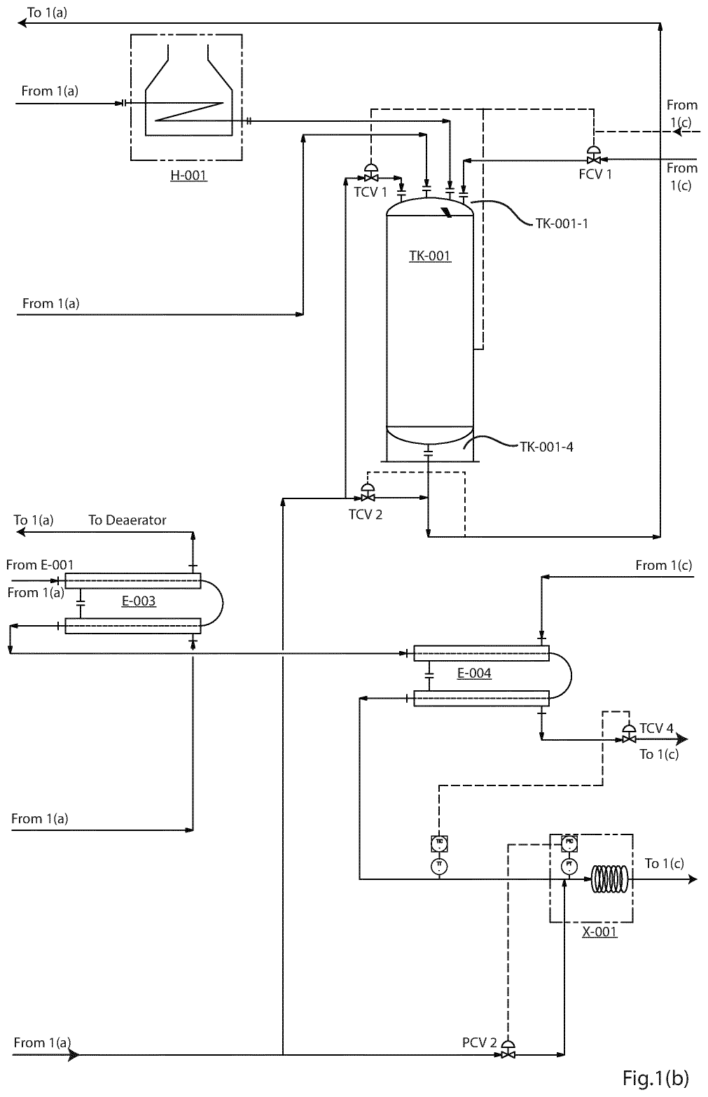

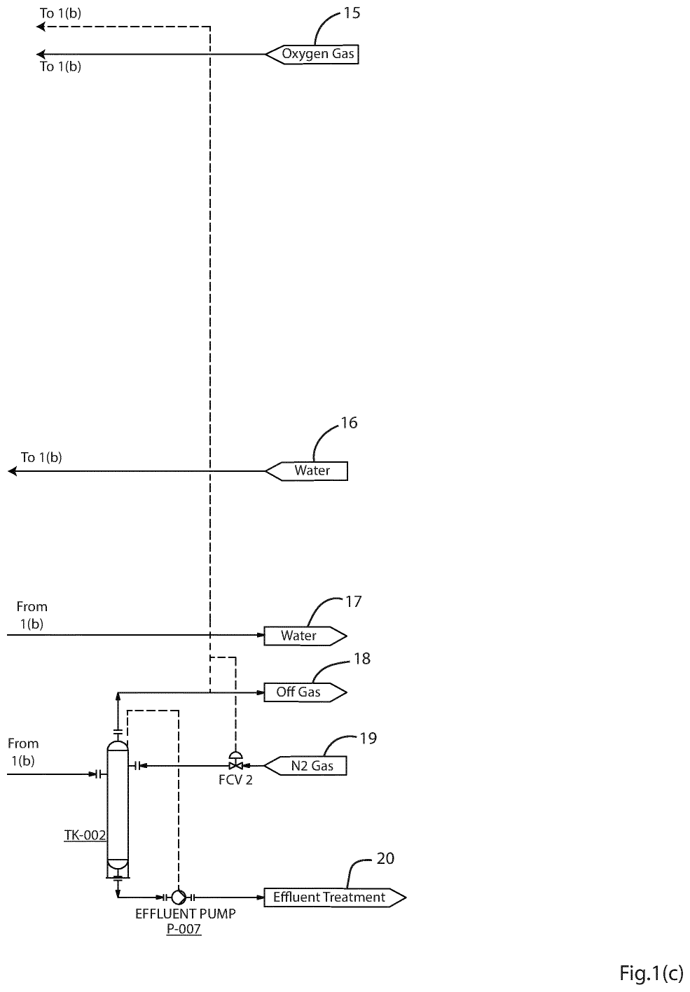

FIGS. 1(a), 1(b), and 1(c) are together is a flow diagram of a method for oxidation of sewage sludge; and

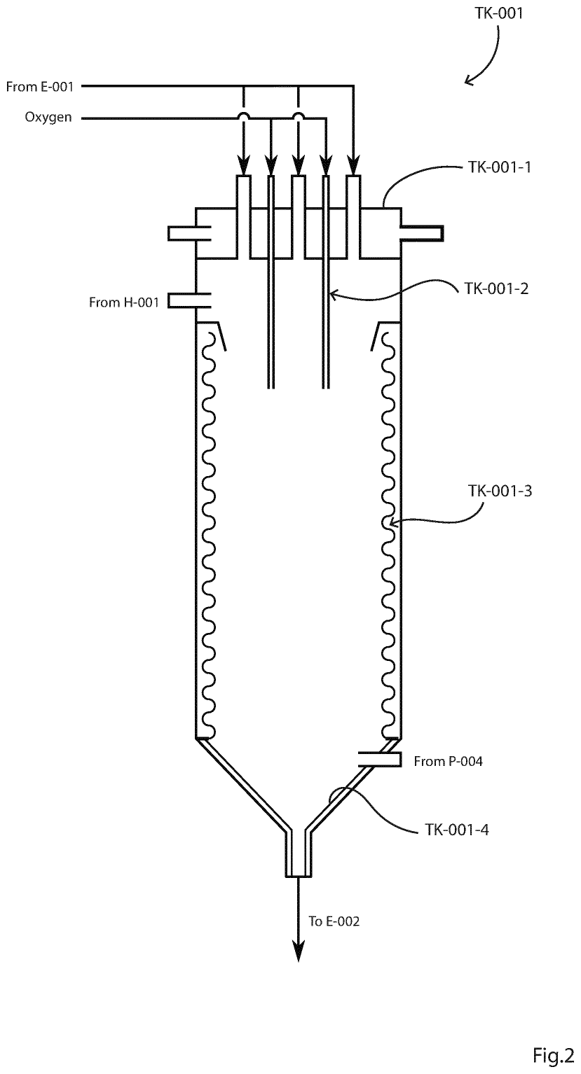

FIG. 2 is a cross-sectional diagram showing a reactor vessel used in the method.

Referring to FIG. 1 a treatment plant 1 has a supercritical water reactor TK-001 which is used to efficiently treat sewage sludge by virtue of its operating parameters and the other components of the plant and how they are operated. Due to the number of components and inter-connections FIG. 1 is spread over three sheets as FIGS. 1(a), (b), and (c). The interrupted lines in FIG. 1 show links from a digital computer controller to the various components, based on sensors for pressure, temperature, and flow rates at parts of the plant. The plant 1 also comprises:
2, steam source;
3, chemical dosing source;
4, deaerator, feeding an economiser heat exchanger E-002, in turn feeding a heater H-001; in turn feeding another inlet of the reactor TK-001;
5, steam vent from the deaerator 4;
6, sludge feed to high-pressure pump P-002 feeding an economiser heat exchanger E-001, in turn feeding the reactor TK-001;
7, water tank linked with a high-pressure water pump P-005 feeding a reverse osmosis (RO) unit 9 for removal of salts from the water source, from which there is an RO reject outlet 8;
10, RO water tank fed by the RO unit 9, and from which water is drawn by a pump P-006, in turn feeding an economiser heat exchanger E-003, which has an outlet to a further economiser heat exchanger E-004 and an outlet to the deaerator 4;
11, water tank feeding a choke/quench water pump P-004 feeding a pressure reducer X-001, the outlet of which is in turn linked with a separator TK-002;
15, oxygen supply to the reactor TK-001 inlet;
16, cooling water/medium supply to the economiser E-004;
17, cooling water/medium outlet from the economiser E-004;
18, off gas vent from the separator TK-002; and
20, effluent outlet fed by a pump P-007 from the bottom of the separator TK-002.

The reactor TK-001 is vertical and has several inlet conduits in the top end. These inlet conduits are, from left to right as viewed in FIG. 1(b):
inlet for water from the source 11 via the pump P-004;
inlet for sludge from the (pre-heating) economiser E-001,
inlet for start-up heated water from the heater H-001, and
inlet for oxygen injection.

As described in more detail below, the reactor retention time is advantageously 1 to 4 minutes, preferably 1 to 2 minutes. As shown in FIG. 2, the inside of the reactor is lined with a corrugated descaling liner TK-001-3 that can expand or contract by deliberately changing reactor temperature. In one possible example the material of construction for the non-pressure bearing liner could be a high nickel alloy. Because the reactor vessel is fitted with the non-pressure bearing liner TK-001-3 with the capability to expand and contract, based on the difference in thermal expansion coefficients between the installed liner and the accumulated salt and/or solid layer, controlled cracking and subsequent dislodgement of solids can be achieved by altering the temperature of the reactor vessel. In this case the liner is undulating in a ribbed configuration, but this is not essential.

The liner may in other examples not be corrugated to increase its range of expansion/contraction, and where it is corrugated the extent of corrugation may vary. The ability of the reactor liner to expand or contract provides a mechanism for descaling baked-on salts and/or residual solid build-up from the treated waste. In one example the temperature is varied to the extent of reducing the reactor temperature by adding quench water (30° C.-50° C.) to the top in order to de-scale it. This is preferably performed at the stage of scheduled cleaning. The requirement for scheduled cleaning is highly dependent on the specific waste treated. At the outlet TK-001-4 of the reactor there is a corrosion-resistant liner, which protects against corrosion as the reactor effluent is quenched from supercritical temperatures (400° C. to 550° C.) down to sub-critical temperatures (200° C. to 300° C.). The liner is made of any suitable material such as specifically selected ceramic that can withstand the reactor outlet conditions. In one example the flow rate in the process is approximately 2 m³/hr.

Suitable waste streams for the process implemented by the plant 1 include sewage sludge streams containing oxidizable material, and the process eliminates or minimises the requirement to preheat the feed material. The cold or warm feed is always introduced into the vessel-type reactor (TK-001) when it contains sufficient mass of water under supercritical conditions to prevent the newly introduced feed from causing the entire reactor contents to fall below supercritical conditions. This is achieved during start-up by using the separate supercritical water generator components ending in the heater H-001 to supply supercritical water to the reactor.

The required flow rate of supercritical water to the reactor varies depending upon the exotherm of the oxidation of the organics within the feed. The feed rate is varied so as to keep the system in balance and always at a temperature in excess of 374° C. and pressure of 230 Bar. Oxygen is used as the oxidant and is dosed in ratio to the feed to the reactor at stochiometric quantum. The reactor is sized to ensure that sufficient retention time is provided for the oxidation reaction to complete. Supercritical water is utilised during the start-up of the process to heat the process equipment and to ensure that processing can always proceed at a reactor temperature in excess of supercritical conditions. Once the process is up to target temperature, sewage sludge or a different waste stream, along with a stoichiometric quantity of oxygen, is introduced to the reactor vessel. At this operating temperature of 425° C. to 550° C., the organics present in the waste stream are oxidised, releasing sufficient energy to allow the reactor content to maintain at least the current reactor temperature. The waste feed to supercritical water ratio is increased when sufficient oxidation exotherm is evident until auto-thermal operation is achieved (i.e. where only a limited supercritical water addition is required to maintain the reactor operating temperature). In the bottom outlet section of the reactor, which includes a corrosion resistant liner and/or a non-pressure bearing corrosive resistant insert, quench cooling cools the process stream from approximately 550° C. to approximately 250° C., preventing corrosion downstream of the reactor. A neutralising additive may or may not be added in the quench stream or at any other suitable location downstream of the reactor. Heat is recovered from the effluent stream, which may preheat the sludge fed to the reactor as well as provide additional energy available for recovery. The process allows for a COD reduction of 85% to 99.9% in a residence time of less than 4 minutes.

The plant has a varying energy demand depending on whether it is in start-up mode or if it is running at steady state. The start-up mode is important to achieve the desired auto-thermal, steady state conditions.

### Plant Start-Up

Demineralised water is fed to the deaerator drum 4 from the R.O water tank using P-006 and subsequently pumped using the high-pressure water pump P-003 shown near the inlet to the economiser E-002, pressurising the plant 1 up to a value in the range of 230 Bar to 320 Bar, more preferably 230 Bar to 250 Bar. Once the plant 1 is at the desired operating pressure, the supercritical water heater H-001 heats the water feed to a temperature in the range of 380° C. to 650° C., preferably 520° C. to 570° C. To control downstream fouling and corrosion, a quench water stream is introduced via a valve TCV 2 into the outlet of the reactor vessel TK-001. This serves as a quench, cooling down the process stream to a temperature in the range of 200° C. to 300° C., preferably 240° C. to 260° C. The liner of the outlet of the reactor TK-001 protects against corrosion attributed to the transition of reactor effluent from the supercritical into the sub-critical regime in the presence of oxygen.

### Introduction of Organic Feedstock

At this point sewage sludge (or another organic waste stream) is pumped to the heat exchanger E-001 at approximately 100 to 300 L/hr by the high-pressure sludge pump P-002. Heat is recovered from the reactor TK-001 outlet stream and is used by the heat exchanger E-001 to preheat the sludge fed into the reactor from 20° C. to 50° C.-200° C. The waste stream is fed to the reactor via a liquid distributor. The liquid distributor may allow for temperature control, ensuring that the distributor wall temperature does not promote bake-on and/or fouling and subsequent blockage.

In the reactor, sewage sludge is combined with oxygen and rapidly heats due to the supercritical water conditions. Waste feed distribution before it enters the reactor ensures an increased area for heat transfer from the supercritical reactor content to the waste and thus rapid heating may be achieved. The rapid heating rate ensures that the sludge achieves near immediate transition from the liquid to the supercritical phase, with the accompanying changes in solvency properties. Inorganic salts, perfectly soluble in a polar sub-critical water solvent, now exist in a system with a solvent displaying characteristics of a non-polar solvent. The inorganic salts, not being allowed time for crystal growth, precipitate from solution as dry salts. A non-pressure bearing liner is installed on the inside of the reactor vessel and attached at one or more mounting points. The liner protrudes above the oxygen injection points. This descaling liner TK-001-3, lining the reactor wall, serves as a surface for preferential salt collection during steady state operation at temperatures of 520° C. to 570° C. The liner may be configured to meet salt nucleation site and angle of inclination requirements for collecting specific salts presented in the feed. The accumulated salt and/or solid substance layer has a thermal expansion coefficient different from the installed liner and controlled cooling of the reactor vessel, allows for controlled discharge of accumulated solids from the vessel walls.

The arrangement of the movable, non-pressure bearing liner TK-001-3 to achieve this descaling effect is shown in FIG. 2. The waste stream fed to the top of the reactor is passed through a distributor unit TK-001-1 with injection conduits that ensure optimal distribution of the waste stream before injection into the reactor. As noted above, the feed distributor has injection conduits (TK-001-2) for oxygen injection. The distributor allows for temperature control of the distributor walls, minimising bake-on and/or fouling and subsequent blockage of the distribution channels. Optimal distribution of waste prior to injection into the reactor allows for rapid heat-up to supercritical conditions.

The bottom section of the reactor TK-001 is lined with a corrosive-resistant material TK-001-4, allowing for quenching the reactor effluent to sub-critical temperatures while at the same time limiting corrosion related to passing through the transition from supercritical to sub-critical conditions. In another arrangement, a non-pressure bearing corrosive resistant insert at the bottom of the reactor (TK-001-4) is used to channel flow of the quench water stream for optimal mixing with the hot reactor effluent stream. Effective mixing of the quench water stream and the reactor effluent stream ensures that limited time is require for the fluid temperature to drop from supercritical conditions to sub-critical conditions, thus controlling the risk of corrosion related to the mentioned transition from supercritical to sub-critical conditions.

The organic content of the feed, fully miscible in the supercritical water, reacts exothermically with the injected oxygen. Energy from the oxidation reactions inside the reactor vessel is absorbed by the process fluid, decreasing the requirement for supercritical water feed from the SCW heater H-001. As the sludge flow rate is incrementally increased, the requirement for adding supercritical water continues to decrease. With the sludge flow rate matching the initial SCW flow rate, the SCW flow rate is decreased to a minimum depending on the reactor temperature.

The reactor TK-001 is sized to accommodate a residence time of up to 4 minutes at the operating conditions outlined, but it may be much shorter, and it is generally preferred that it be in a range of less than 2 min.

The effluent from the reactor is rapidly cooled to a value in the range of 200° C. to 300° C., preferably 240° C. to 260° C., by the addition of quench water from via TCV 2. The quench stream is introduced into the bottom section of the reactor. The outlet of the reactor has a corrosion-resistant liner, which protects against corrosion as the reactor effluent is quenched from supercritical temperatures (400° C. to 550° C.) down to sub-critical temperatures (200° C. to 300° C.). The flow rate required to quench the reactor outlet (520° C. to 570° C.) to the required temperature is approximately double the flow of the feed to the reactor. Quench water can be added to the top of the reactor vessel TK-001 via TCV 1, if required to quench cool the reactor during operation or during the descaling process.

The plant allows for the use of inline neutralisation depending on the waste material being processed. This may be achieved by dosing neutralisation agent to the bottom of the reactor with the quench stream or at any other suitable location downstream from the reactor. The quenched effluent stream, now at 240° C. to 260° C., is passed through heat exchangers E-002 and E-001, where respectively heat is recovered by preheating the water feed to the SCW heater, H-001, and preheating of the sludge feed to the reactor.

Post E-001, the effluent stream from the reactor has a temperature of 200° C. to 220° C. and further waste heat recovery is achieved by means of either pre-heating the de-ionised water before feeding it to the deaerator, or converting waste heat to electrical heat by utilising an Organic Rankine Cycle (ORC).

After heat recovery from the reactor effluent stream, a heat exchanger E-004 utilises cooling water to cool the stream to 40° C. to 60° C. before the pressure let-down system.

The flow scheme employs a pressure let-down step where the effluent pressure is reduced from approximately 230 Bar to 250 Bar to atmospheric pressure. The pressure drop is achieved by the introduction of choke water from a choke/quench water pump, P-004, and subsequently passing the effluent stream through several continuous capillary coils X-001 (the back-pressure control system) with small internal dimensions. The pressure let-down system ensures a gradual pressure let-down without the use of any hard restrictions (valves or orifice plates) in the process line. This achieves excellent pressure control and let-down reliability and largely eliminates the need for maintenance on the pressure let-down step.

The effluent stream, at now-reduced pressure, is sent to a gas-liquid separator (TK-002) from where the gas-free liquid effluent is either pumped or flows under gravity to neutralisation or disposal. There is online measurement of the percentage oxygen in the largely Carbon dioxide rich effluent-gas stream, allowing for controlling the oxygen input to the reactor. The oxidation process will generate Carbon Dioxide equal to approximately 144% of the Oxygen consumed, in one example. The Oxygen control allows for driving the oxidation reactions and the related COD destruction to full or near completion. The process allows for a COD reduction of 85% to 99.9% under high pressure and high temperature conditions utilising greater than 95% oxygen as the oxidising agent.

Starting up the process for the oxidation of sludge is energy intensive and energy for heating up to the operating temperature is supplied by the supercritical water heater, H-001. As the oxidation of sewage sludge commences, and the process progresses to full sludge flow, the energy released from the oxidation reactions may result in up to 98% reduction in the energy requirement.

The process holds many advantages above alternative processes such as incineration and conventional oxidation. The SCW heater allows for providing the heat requirement for start-up until energy from the sludge combustion is released to replace the energy from the SCW heater. Gradual switchover from SCW heater feed to waste feed allows for auto-thermal conditions to be achieved, limiting the energy requirement from the SCW heater. Injection of oxygen into the reactor at supercritical conditions ensures perfect miscibility between oxygen gas and the COD containing components within the waste, presenting no restriction to the reaction rate due the mass transfer limitation. At sub-critical conditions this is normally the rate-limiting factor in the oxidation reactions. High operating temperatures ensure rapid and complete oxidation reactions. Waste feed to the reactor is distributed via a temperature-controlled liquid distributor allowing for control of the distributor wall temperatures, eliminating fouling, bake-on and subsequent blockage of the distribution channels.

As described above, the inside of the reactor vessel is lined with a non-pressure bearing liner that protrudes above and encapsulates the feed and oxygen injection point. The section between the reactor wall and the plate is filled with SCW. The surface of the plates serves as a preferential nucleation site and/or collection of “dry salts”. The non-pressure bearing liner TK-001-3 inside the reactor has a thermal expansion coefficient different from the collected salt layer on the liner internal surface and allows for controlled release of collected salts by deliberately altering the reactor temperature.

The corrosion-resistant lined reactor outlet TK-001-4 allows for rapid cooling of the reactor effluent, reducing the impact of corrosion attributed to the transition from the supercritical to the sub-critical regimes. The rapid quench at the reactor outlet ensures that the energy released from the exothermic reactions is harnessed by means of increasing mass flow rate to the heat exchanger used to preheat the feed to the reactor.

Quenching of the reactor effluent stream, downstream of the process feed lines and the reactor, ensures that reactor equipment can be small. The process stream flow rate increases by 200% downstream of the reactor. The rapid quench cooling of the reactor effluent from a value in the range of 520° C. to 570° C. to a value in the range of 240° C. to 260° C. reduces the risk of corrosion in the equipment downstream from the reactor.

The quench of the reactor effluent stream ensures that inorganic salts, insoluble in SCW, are dissolved in the polar solvent (water at sub-critical conditions) and reduces the impact of solids on erosion and/or blockages of downstream process equipment.

Dosing of a neutralisation agent with the quench water allows for inline adjustment of the reactor effluent pH, further protecting downstream equipment against corrosion. The corrosion resistant liner and/or non-pressure bearing corrosion resistant insert, at the reactor outlet, allows operating in the transition between supercritical and near-critical range, limiting the impact of corrosion related to the mentioned transition.

The process allows for control over the oxygen injection based on the oxygen present in the off-gas, reducing losses due to excess oxygen addition to the reactor. This ensures complete to near-complete oxidation of sludge.

Use of choke water ensures safe and reliable pressure control and pressure let-down from pressures in the supercritical range, typically 230 bar to 320 bar, to atmospheric conditions. Use of capillary coils in the pressure let-down system eliminates the requirement for pressure control valves, increases reliability and decreases the maintenance requirement on equipment operating at pressures between 230 bar to 320 bar. Also, use of a series of economiser heat exchangers recovers energy from the reactor effluent, pre-heating both the water and the sludge feed streams.

The system does not produce a hot off gas stream that requires special consideration.

Also, the addition of oxygen to the reactor is optimised, ensuring the addition of near stoichiometric oxygen requirements. Also, the process eliminates or greatly reduces:
use of high temperature heat exchanger for feed heating up to super critical water conditions,
problems associated with grit handling,
problems associated with erosion,
problems associated with process blockages due to salt precipitation from supercritical fluid,
problems associated with metal corrosion normally associated within the phase transition from supercritical to near critical conditions and down to 250° C.,
the previous requirement to use high-pressure, high-temperature corrosion-resistant valves.

The invention is not limited to the embodiments described but may be varied in construction and detail. It is envisaged that CO levels may be monitored in the reactor off-gas to enable operation at zero excess oxygen to avoid corrosion.

The apparatus may be adapted for recycling of treated liquid effluent to be reused in the process as quench water. This is dependent on the suitability of the treated effluent to be recycled. Recycling treated effluent vastly improves the utility input requirement of the plant, eliminating the requirement for water make-up.

Also, the apparatus may be adapted for process stream pressure reduction from 230-320 Bar to 60-80 Bar, immediately downstream from the water quench section (TK-001-4) at temperatures between 240° C. and 260° C. The method of pressure reduction is similar to what is described for the pressure reduction system (X-001). This allows for reduced pressure ratings on process equipment (for example, E-001, E-002, E-003 and E-004) downstream of the reactor and optimisation on capital expenditure requirement.

Also, the apparatus may be adapted to perform high pressure gas-liquid separation following on from the above pressure reduction. High pressure gas-liquid separation ensures removal of the gaseous component from the liquid stream before heat is recovered in the downstream heat recovery heat exchangers (E-001, E-002, E-003), increasing heat transfer efficiency.

Further, there may be a second pressure reduction step using X-001 following on from the above pressure reduction, decreasing the system pressure from a value in the range of 60 Bar to 80 Bar to atmospheric pressure after which it passes to the gas liquid separator TK-002 for degassing of the final effluent (as shown in FIG. 1(c)). Moreover, there may be a quench water recycle stream tie-off connection upstream of the above second pressure let-down step. This allows for a suction pressure of 60 Bar to 80 Bar to the quench water pump P-004, thereby reducing the operating energy requirement of the pump by 25% to 30%.

1-34. (canceled)

35. A process performed by a plant for oxidation of a waste stream with oxidizable material, the process comprising the steps of:
in a start-up phase feeding supercritical water to a reactor, gradually introducing the waste stream and oxidant, and simultaneously decreasing supercritical water feed while maintaining supercritical conditions in the reactor, and
in a treatment phase, then feeding the waste stream with oxygen to the reactor for supercritical oxidation, in which sufficient mass of water under supercritical conditions is present to retain supercritical conditions with the energy released from oxidising the introduced waste stream.

36. The method as claimed in claim 35, wherein a separate supercritical water generator supplies supercritical water to the reactor.

37. The process as claimed in claim 35, comprising during the treatment phase varying waste stream feed rate to maintain the reactor in balance and at a temperature in excess of 374° C. and pressure in excess of 230 bar and a retention time in the range of 1 to 4 minutes, preferably 1 to 2 minutes.

38. The method as claimed in claim 35, wherein during the treatment phase Oxygen is used as the oxidant and it is dosed in ratio to the waste stream feed to the reactor at stochiometric quantum.

39. The method as claimed in claim 35, wherein during the treatment phase the reactor operating temperature is in the range of 425° C. to 550° C.

40. The method as claimed in claim 35, including during the treatment phase quench cooling at the reactor outlet to quench a treated effluent stream to prevent corrosion downstream from the reactor; wherein the quenching reduces temperature of the effluent stream to a value in the range of 200° C. to 300° C.; wherein heat is recovered from the effluent stream for preheating of the waste stream fed to the reactor; and wherein a neutralisation agent is dosed with quench water to the bottom of the reactor with the purpose of adjusting the reactor effluent pH

41. The method as claimed in claim 35, wherein in the start-up phase demineralised water is fed to a deaerator drum and subsequently pumped using a high-pressure water pump, pressurizing the plant to elevate pressure above 220 Bar, and when the plant is at a desired operating pressure a supercritical water heater heats start-up phase water feed to a temperature in the range of 380° C. to 650° C.

42. The method as claimed in claim 35, wherein during the treatment phase heat is recovered from the reactor outlet effluent stream by a heat exchanger to preheat the waste stream fed into the reactor to a value in the range of 50° C. to 200° C.

43. The method as claimed in claim 35, wherein during the treatment phase the waste feed to the reactor is distributed prior to injection into the reactor; and wherein the waste stream is distributed using a distributer equipped with temperature control, avoiding distributor wall temperatures that promote bake-on and/or fouling and sub-sequent distribution channel blockage; and including rapid heating of the waste stream feed by increased surface area for heat transfer between the distributed waste and the reactor content at supercritical conditions.

44. The method as claimed in claim 35, wherein the reactor conditions are such that the waste stream rapidly heats due to the supercritical water conditions, so that the waste stream transitions immediately from liquid to the supercritical phase, with the accompanying changes in solvency properties, and in which inorganic salts display characteristics of a non-polar solvent, and due to there not being allowed time for crystal growth, precipitate from solution as dry salts.

45. The method as claimed in claim 35, wherein the reactor comprises a liner having a surface for preferential salt collection during steady state operation, which may be at a temperature in the range of 380° C. to 650° C.

46. The method as claimed in claim 35, wherein the reactor comprises a liner having a surface for preferential salt collection during steady state operation, which is at a temperature in the range of 380° C. to 650° C.; and wherein the liner is configured to meet salt nucleation site requirements and angle of inclination for collecting specific salts presented in the feed; and wherein the liner is non-pressure bearing and has a thermal expansion coefficient different from a collected salt scaling and/or fouling layer, allowing controlled release of collected salts by deliberately altering the reactor temperature; and wherein the reactor content is quench cooled for descaling, including allowing the reactor liner to contract with subsequent dislodgment of scale build-up.

47. The method as claimed in claim 35, wherein during the treatment phase after heat recovery from the reactor effluent stream, cooling water is used to cool the effluent stream to a value in the range of 40° C. to 60° C. before a pressure let-down step in which the effluent pressure is reduced to atmospheric pressure.

48. The method as claimed in claim 35, wherein during the treatment phase after heat recovery from the reactor effluent stream, cooling water is used to cool the effluent stream to a value in the range of 40° C. to 60° C. before a pressure let-down step in which the effluent pressure is reduced to atmospheric pressure; and wherein the pressure drop is achieved by introduction of choke water and subsequently passing the effluent stream through a capillary coil for a gradual pressure let-down without valves or orifice plates.

49. The method as claimed in claim 35, wherein during the treatment phase after heat recovery from the reactor effluent stream, cooling water is used to cool the effluent stream to a value in the range of 40° C. to 60° C. before a pressure let-down step in which the effluent pressure is reduced to atmospheric pressure; and wherein the reduced-pressure effluent stream is processed by a gas-liquid separator from which a gas-free liquid effluent is disposed; and wherein oxygen measurement of the effluent gas stream is performed and oxygen input to the reactor is controlled accordingly to achieve desired COD destruction.

50. The method as claimed in claim 35, wherein there is a gradual switch-over from the start-up phase to achieve auto-thermal reactor conditions; and comprising recycling treated liquid effluent by reusing it in the reactor as quench water.

51. The method as claimed in claim 35, comprising performing process stream pressure reduction from a value in the range of 230 Bar to 320 Bar to a value in the range of 60 Bar to 80 Bar, downstream from a water quench section of the reactor outlet at a temperature between 240° C. and 260° C.; and comprising the step of performing high pressure gas-liquid separation after said pressure reduction, for removal of a gaseous component from the liquid stream before heat is recovered in a downstream heat recovery heat exchanger.

52. The method as claimed in claim 35, comprising performing process stream pressure reduction from a value in the range of 230 Bar to 320 Bar to a value in the range of 60 Bar to 80 Bar, downstream from a water quench section of the reactor outlet at a temperature between 240° C. and 260° C.; and further comprising a second effluent pressure reduction step downstream of said pressure reduction, decreasing the effluent pressure from a value in the range of 60 Bar to 80 Bar to about atmospheric pressure after which it passes to the gas liquid separator for degassing; and comprising application of a suction pressure of 60 Bar to 80 Bar to a quench water pump, thereby reducing operating energy requirement of the pump.

53. A treatment apparatus comprising process components including a controller with a data processor and a supercritical reactor and adapted to perform the steps of:
in a start-up phase feeding supercritical water to the reactor, gradually introducing waste and oxidant, and simultaneously decreasing supercritical water feed while maintaining supercritical conditions in the reactor, and
in a treatment phase, then feeding the waste stream with oxygen to the reactor for supercritical oxidation, in which sufficient mass of water under supercritical conditions is present to retain supercritical conditions with the energy released from oxidising the introduced waste stream.

54. The treatment apparatus as claimed in claim 53, wherein the reactor is vertically arranged; and wherein the reactor comprises a distributor adapted to receive the waste stream fed to the top of the reactor.

55. The treatment apparatus as claimed in claim 53, wherein the reactor comprises a non-pressure bearing liner with a capability to expand and contract, such that based on a difference in thermal expansion coefficients between the liner and accumulated solids, controlled cracking and subsequent dislodgement of the solids can be achieved by altering the temperature of the reactor.

56. The treatment apparatus as claimed in claim 53, wherein the reactor outlet is lined with a corrosive-resistant material, allowing for quenching reactor effluent to sub-critical temperatures while at the same time limiting corrosion related to passing through the transition from supercritical to sub-critical conditions.
